(19) United States
(12) Patent Application Publication
(10) Pub. No.: US 2020/0142193 A1
(43) Pub. Date: May 7, 2020

(54) Projection Device for a Head-Mounted Display, Head-Mounted Display, and Method for Improving the Symmetry of a Light Beam and/or Reducing the Diameter of the Light Beam

(71) Applicant: Robert Bosch GmbH, Stuttgart (DE)

(72) Inventor: Tobias GRAF, Stuttgart (DE)

(21) Appl. No.: 16/626,421

(22) PCT Filed: Jun. 21, 2018
(86) PCT No.: PCT/EP2018/066572

§ 371 Date: Dec. 24, 2019

(30) Foreign Application Priority Data
Jul. 12, 2017 (DE) 10 2017 211 934.9

(51) Int. Cl. G02B 27/01

(52) U.S. Cl. CPC G02B 27/0172; G02B 2027/011; G02B 2027/0178; G02B 2027/0174

(57) ABSTRACT

A projection device for a head-mounted display includes at least one light source for emitting at least one light beam, at least one collimation element for collimating the at least one light beam emitted by the light source, at least one deflecting element which is arranged or can be arranged on a lens of the head-mounted display for projecting an image onto a retina of a user of the head-mounted display by deflecting and/or focusing the at least one light beam onto an eye lens of the user, and at least one reflection element for reflecting the collimated light beam onto the deflection element. The projection device further includes at least one optical correction element which has a rotationally non-symmetrical optical element for improving the symmetry of the light beam and/or for reducing the spot size of the light beam.

The present invention relates to a projection device for a pair of smart glasses, a pair of smart glasses, a method for improving a symmetry of a light beam and/or reducing the diameter of a light beam, a computer program, a machine-readable storage medium, and an electronic control unit.

### PRIOR ART

A trend expected in the future is the wearing of smart glasses, which can overlay virtual items of image information into the field of view of a user. While current smart glasses are not transparent, for example, and thus hide the surroundings, more recent concepts follow the approach of overlaying virtual image contents with the surroundings. Overlaying virtual image contents with the surroundings, which are additionally still perceived, is referred to as augmented reality. One application is, for example, the overlay of items of information when carrying out professional activities. A mechanic could thus see a technical drawing or the smart glasses could identify specific regions of a machine by color. However, the concept is also applied in the field of computer games or other leisure activities.

Transparent head-mounted displays (HMD), for example, for applications in the field of augmented reality (AR), are an active theme in research and development. In particular the interest in the development of more cost-effective, lighter, more economical systems having small form factor is of great interest, both for industrial applications and also for the end user. One possible technical use for such a display is based in this case on the concept of a flying spot laser projector, with the aid of which the image information is written directly on the retina of the user. Such HMDs are therefore also referred to as retina scanners.

The concept is based on a single light beam, in particular a laser beam, being scanned over an angle range by means of an electronically activated scanner optical unit, for example a MEMS (micro-electromechanical system) mirror. For example, the beam can be scanned over the glasses lens in this manner. To ensure that the scanned beam then reaches the eye of the observer or its pupil, respectively, in general a deflection of the incident beam is necessary. In this case, the law of reflection, according to which angle of incidence is equal to angle of reflection, is generally infringed for geometrical reasons. This can be implemented technically, for example, by the application of a holographic optical element (HOE) on the glasses lens. The HOE is typically implemented in this case by a photopolymer layer.

DE 10 2012 219 723 A1 discloses a field of view display device for projecting an item of graphic information for an observer in an eye area of the field of view display device, wherein the field of view display device comprises a projector and a projection surface unit. The projector is designed to provide the graphic information in the direction of an optical axis of the field of view display device. The projection surface unit is designed to convert the graphic information into a real image. The projection surface unit is arranged in the optical axis between the projector and an image output of the field of view display device. The projection surface unit comprises a volume hologram having a scattering characteristic oriented onto the eye area for the information or is embodied as a volume hologram having a scattering characteristic oriented onto the eye area for the graphic information.

### DISCLOSURE OF THE INVENTION

The projection device for a pair of smart glasses comprises at least one light source for emitting at least one light beam.

A light source can be understood as a light-emitting element, for example, a light-emitting diode, in particular an organic light-emitting diode, a laser diode, or an arrangement made of multiple such light-emitting elements. In particular, the light source can be designed to emit light of different wavelengths. The light beam can be used for generating a plurality of pixels on the retina, wherein the light beam can scan the retina, for example, in rows and columns or in the form of Lissajous patterns and can be pulsed accordingly. A glasses lens can be understood as a pane element manufactured from a transparent material such as glass or plastic. Depending on the embodiment, the glasses lens can for example be formed as a corrective lens or can comprise tinting for filtering light of specific wavelengths, for example UV light.

A light beam can be understood as a Gaussian beam in the paraxial approximation.

The projection device furthermore comprises at least one collimation element for collimating the at least one light beam emitted from the light source. The collimation element is preferably arranged directly after the light source. If multiple light sources are used, the number of the collimation elements is preferably identical to the number of the light sources. In this case, it is furthermore preferable for a collimation element to be arranged in each case directly after each light source.

The projection device furthermore comprises at least one deflection element, which is arranged or can be arranged on a glasses lens of the smart glasses, for projecting an image onto a retina of a user of the smart glasses by deflecting and/or focusing the at least one light beam onto an eye lens of the user. The deflection element can be a holographic element or a free-form mirror.

A holographic element can be understood, for example, as a holographic optical element, abbreviated HOE, which can fulfill, inter alia, the function of a lens, a mirror, or a prism. Depending on the embodiment, the holographic element can be selective for specific colors and angles of incidence. In particular, the holographic element can fulfill optical functions which can be written or imprinted using simple point light sources in the holographic element. The holographic element can thus be produced very cost-effectively.

The holographic element can be transparent. Items of image information can thus be overlaid with the surroundings.

A light beam can be deflected onto a retina of a wearer of a pair of smart glasses by a deflection element arranged on a glasses lens of the smart glasses in such a way that the wearer perceives a sharp virtual image. For example, the image can be projected directly onto the retina by scanning a laser beam over a micromirror and the holographic element.

Such a projection device can be implemented comparatively cost-effectively on small structural space and enables an image content to be brought into a sufficient distance from the wearer. The superposition of the image content with the image of the surroundings on the retina is thus enabled. Because the image can be written by means of the holographic element directly onto the retina, a planar display element, for example an LCD-based or DMD-based system, can be omitted. Furthermore, a particularly large depth of field can thus be achieved.

In general, the reflection behavior on the surface of the holographic element is different at each point. As already mentioned, it is generally not true that the angle of incidence is equal to the angle of reflection. The subregion of the surface of the holographic element which is used to deflect the light beam to the eye of a user is referred to as the functional region.

In principle, the same statements apply for a free-form mirror as for a holographic element.

The projection device furthermore comprises at least one reflection element for reflecting the collimated light beam onto the deflection element. A reflection element can be understood, for example, as a mirror, in particular a micromirror or an array of micromirrors, or a hologram. A beam path of the light beam can be adapted to given spatial conditions by means of the reflection element. For example, the reflection element can be implemented as a micromirror. The micromirror can be embodied as movable, for example it can comprise a mirror surface which can be inclined around at least one axis. Such a reflection element offers the advantage of a particularly compact structural form. It is furthermore advantageous if the reflection element is designed to change an angle of incidence and, additionally or alternatively, a point of incidence of the light beam on the holographic element. The holographic element can thus be scanned flatly, in particular, for example, in rows and columns, using the light beam.

Furthermore, the reflection element can be a mirror having deformable surface. This has the advantage that the reflection element not only can deflect the light beam, but rather also can change beam parameters.

Furthermore, the projection device comprises at least one correction optical unit, which comprises a non-rotationally symmetrical optical element for improving the symmetry and/or for reducing, in particular minimizing, the spot size of the light beam. The correction optical unit is preferably arranged after the at least one collimation element. For the case in which multiple light sources having different wavelengths are used, which are united to form one light beam, one correction optical unit can respectively be provided for each light beam before the beam unification. For this case, a single correction optical unit can also be provided after the beam unification, which is preferably designed for all three wavelengths, i.e., as general-wavelength. According to a further embodiment, in this case, three correction optical units can also be provided before the beam unification and one correction optical unit can be provided after the beam unification.

This modification of the optical system by at least one additional optical element which comprises a non-rotationally symmetrical optical element advantageously enables an expansion of the design approach by additional design parameters. These can be used both for reducing the spot size on the retina in the design optimization, and also for influencing the symmetry properties of the light beam in the different system configurations.

According to one embodiment, the non-rotationally symmetrical optical element is a cylinder lens. The concept of rotational symmetry relates here to the symmetry of the optical element with respect to the optical axis. In general, non-rotationally symmetrical optical elements change the beam parameters along an axis of the light beam differently than the beam parameters with respect to a further axis perpendicular to this axis. The non-rotationally symmetrical optical element can comprise, for example, two crossed cylinder lenses or one free-form surface. The non-rotationally symmetrical optical element can preferably comprise a diffractive optical element (DOE). Diffractive optical elements have the advantage of a low weight.

According to a further embodiment, the non-rotationally symmetrical optical element is not a diffractive optical element.

According to a further embodiment, the projection direction furthermore comprises at least one adaptive optical element for adaptively changing at least one beam parameter, wherein the at least one adaptive optical element is arranged in the beam path between the at least one light source and the at least one holographic element.

An adaptive optical element can be understood as any optical element which is capable of changing a beam parameter. Since an optical element generally can change a beam parameter at the location of the optical element only slightly, the term beam parameter is to be understood in particular as a beam parameter at a location which is located after the optical element. Beam parameters can be, inter alia, the following: divergence angle or beam divergence, beam waist or beam diameter and distance of the light beam from the optical axis. It is also to be noted in this case that a light beam is generally not rotationally symmetrical. This means that the behavior of a light beam can be different in, for example, two directions orthogonal to one another. In general, a light beam is described at a location by two beam waists and two divergence angles.

The adaptive optical element can be embodied as switchable. For example, a control unit which regulates the adaptive optical element can be provided. In this case, the optical system can be actively adapted to different system configurations or also to different users.

The adaptive optical element can comprise or be a lens having variable refraction properties, in particular a lens having variable focal length, a liquid lens having variable focal length, a telescope having variable focal length, a telescope having variable lens distances, a mirror having variable reflection properties, a mirror having deformable surface, a liquid crystal mirror, a liquid crystal display (SLM (spatial light modulator)/LCoS (liquid crystal on silicon)), or an SLM in reflection based on liquid crystal technology. The telescope can comprise, for example, a Galilean or Keplerian arrangement.

A telescope having variable focal length can be implemented, for example, by a conventional telescope in which the distance of the lenses from one another can be varied. Alternatively or additionally, a focal length of one or more lenses can be changed. In addition, the shape of the lens can be variable in an asymmetrical manner, to compensate for or induce astigmatisms, for example.

The mirror having deformable surface changes its surface shape upon application of an electrical voltage. The optical properties of the mirror thus change, in particular the focal length. However, beamforming is also possible, i.e., a change of the beam profile. A mirror could thus be attached in the optical path before the scanning micromirror. The scanning micromirror, i.e., the reflection element, can also be refined so that it additionally deforms simultaneously during the scanning movement.

In the adaptive optical element, non-rotationally symmetrical changes are also possible, so that, for example, beam forms and astigmatisms can also be influenced. This can be implemented, for example, by a liquid lens having segmented electrodes for astigmatic lens profiles.

According to one embodiment of the projection device, the at least one correction optical unit comprises an adaptive optical element or is such an element. According to a further embodiment of the projection device, the at least one collimation element comprises at least one adaptive optical element or is such an element. According to a further embodiment, the projection device comprises at least one correction optical unit having an adaptive optical element and at least one collimation element having an adaptive optical element. In this way, the at least one correction optical unit or the at least one collimation element can advantageously adaptively change, control, or regulate a beam parameter of the light beam.

It is preferable for only one reflection element to be used for a projection device. This has the advantage that a simple structure can be used and the smart glasses have a light construction.

According to a further embodiment, the projection device comprises three light sources each for emitting one light beam, wherein the three light sources each have different wavelengths. The three different wavelengths of the three light sources preferably form an RGB color space. The light source is preferably monochromatic or quasi-monochromatic. An RGB color space is an additive color space, which simulates color perceptions by the additive mixing of three base colors (red, green, and blue). The three different wavelengths are capable of generating an impression of an additive color mixing in a user. This embodiment has the advantage that any arbitrary color recognizable to humans can be projected using these three light sources.

The three light beams are preferably unified to form a single light beam. A light guide having diffractive coupling elements or dichroic beam splitters is preferably used for unifying the light beams of the three light sources. Alternatively to dichroic beam splitters, dichroic filters or dichroic mirrors can also be used.

Each beam path of the three light beams preferably comprises at least one adaptive optical element. In this case, a beam path is to be understood as the path from the light source up to the location where the light beam is absorbed. The at least one adaptive optical element, if it is arranged after a beam unification of the three light beams, can therefore also only be a single one. In this way, a beam parameter can advantageously be changed for each light beam. Each beam path of the three light beams particularly preferably comprises precisely one adaptive optical element.

Before a unification of the light beams of the three light sources, wavelength-specific optical units are preferably used for each light beam. After a unification of the light beams of the three light sources, general-wavelength optical units are preferably used for the unified light beam.

The at least one adaptive optical element is preferably arranged after a unification of the light beams of the three light sources. This has the advantage that a simple structure can be implemented and the number of the switchable optical components can be reduced, in particular to a minimum.

The at least one adaptive optical element is preferably arranged before a unification of the light beams of the three light sources. This is particularly preferable if the collimation element or the correction optical unit comprises an adaptive optical element.

The invention furthermore comprises a pair of smart glasses. These comprise a glasses lens and an above-described projection device, wherein the deflection element is arranged on the glasses lens.

The invention furthermore comprises a method for improving a symmetry of a light beam and/or for reducing the diameter of the light beam, which is used in a projection device for a pair of smart glasses. The improvement of the symmetry of the light beam and the reduction of the diameter of the light beam preferably take place on the projection surface, i.e., on the retina of a user. The method is preferably used for minimizing the diameter of the light beam.

In a first step of the method, a projection device is provided for a pair of smart glasses. This projection device comprises the following features: at least one light source for emitting at least one light beam, at least one collimation element for collimating the at least one light beam emitted by the light source, at least one deflection element, which is arranged or can be arranged on a glasses lens of the smart glasses, for projecting an image onto a retina of a user of the smart glasses by deflecting and/or focusing the at least one light beam on an eye lens of the user, and at least one reflection element for reflecting the collimated light beam onto the deflection element.

In a second step of the method, at least one correction optical unit is added to the projection device. The statements already made above in conjunction with the projection device apply to this correction optical unit.

The correction optical unit is preferably arranged in the beam path between the at least one light source and the at least one deflection element.

In a third step of the method, a multiconfiguration optimization is carried out for the optical components of the projection device. This multiconfiguration optimization is used to improve a symmetry of the light beam and/or to reduce or minimize the diameter of the light beam. The method of the multiconfiguration optimization is preferably used to minimize the diameter of the light beam.

Since in general the demands on the projection device which are advantageous for one configuration possibly result in a worsening in another configuration, in such a case, a multiconfiguration optimization is carried out to minimize the diameter of the light beam on the retina.

Such an optimization can be performed, for example, via the design parameters of the collimation element, in particular the distance to the light source and the focal length of the collimation element.

The multiconfiguration optimization is preferably carried out in that a position, an orientation, or optionally a focal length is varied within predetermined limits for each component of the projection device until an optimum value has been found for all possible configurations of the projection device.

The optimum value can relate in this case to a symmetry of the light beam. This symmetry of the light beam is preferably optimal on the retina of the user. Furthermore, the optimal value can relate to the spot size or the diameter of the light beam. The diameter of the light beam is preferably optimal on the retina of the user.

The predetermined limits of the variation of each component are given by the structural form of the projection device and/or the smart glasses.

One advantage of the method is that by adding a correction optical unit comprising a non-rotationally symmetrical optical element, an expansion of the design approach by additional design parameters is achieved.

These additional design parameters can be used both for reducing the diameter of the light beam on the retina in the design optimization and also for influencing the symmetry properties of the light beam in the different system configurations.

The invention furthermore comprises a computer program which is configured to carry out the described steps of the method to improve a symmetry of the light beam and/or to reduce the diameter of the light beam using this computer program. Furthermore, the invention comprises a machine-readable storage medium, on which such a computer program is stored, and an electronic control unit, which is configured to operate a projection device for a pair of smart glasses or a pair of smart glasses by means of the described steps of the method. Such an electronic control unit can be integrated, for example, as a microcontroller into a projection device or a pair of smart glasses.

Further advantages and designs of the invention result from the description and the appended drawings.

It is apparent that the above-mentioned features and the features still to be explained hereafter are usable not only in the respective specified combination, but rather also in other combinations or alone, without leaving the scope of the present invention.

### BRIEF DESCRIPTION OF THE DRAWINGS

Exemplary embodiments of the invention are illustrated in the drawings and are explained in greater detail in the following description.

FIG. 1 shows a schematic illustration of a projection device according to one embodiment;

FIGS. 2 to 9 each show a schematic illustration of a scanner optical unit of a projection device according to one embodiment; and

FIG. 10 shows a schematic illustration of a pair of smart glasses according to one embodiment.

### EXEMPLARY EMBODIMENTS OF THE INVENTION

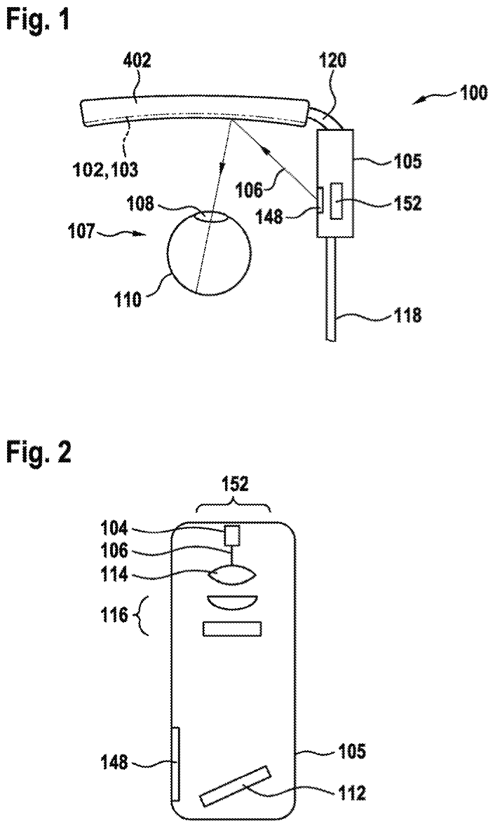

FIG. 1 shows the functionality in principle of the projection device 100. The projection device 100 comprises a scanner optical unit 152 and a deflection element 102, which is embodied in this embodiment as a holographic element 103. The holographic element 103 is fastened on a glasses lens 402. The scanner optical unit 152 is arranged in a housing 105 and comprises a light source, a collimation element, and a reflection element, which are not shown in FIG. 1. Different embodiments of the scanner optical unit 152 are shown in FIGS. 2 to 9.

A light beam 106 emitted by the scanner optical unit 152 is transmitted through an exit window 148 in the direction of the deflection element 102. The light beam 106 deflected by the deflection element 102 is then incident on an eye lens 108 of a user, from which the light beam 106 is focused on the retina 110 of an eye 107. The scanner optical unit 152 is arranged in a housing 105 fastened on the glasses frame 120 and on the glasses earpiece 118.

FIG. 2 shows a scanner optical unit 152, which is enclosed in a housing 105. The scanner optical unit 152 forms, together with the deflection element (not shown), a projection device 100, as shown in FIG. 1. The light source 104 emits a light beam 106, which is collimated by the collimation element 114. The collimated light beam 106 is then incident on a correction optical unit 116. For reasons of comprehensibility, the light beam 106 after the collimation element 114 is not shown in FIGS. 2 to 9. The correction optical unit 116 is illustrated in the present case as a combination of two cylinder lenses having longitudinal axes arranged perpendicular to one another. This combination is representative of an arbitrary above-described correction optical unit. Such a correction optical unit is used to improve the symmetry of the light beam and reduce or minimize the spot size of the light beam and comprises two non-rotationally symmetrical optical elements.

After the light beam 106 has passed through the correction optical unit 116, it is incident on a reflection element 112 and is reflected thereby through an exit window 148 in the direction of a deflection element attached to a glasses lens. The correction optical unit 116 is only designed and optimized for one wavelength, namely for the one used by the light source 104.

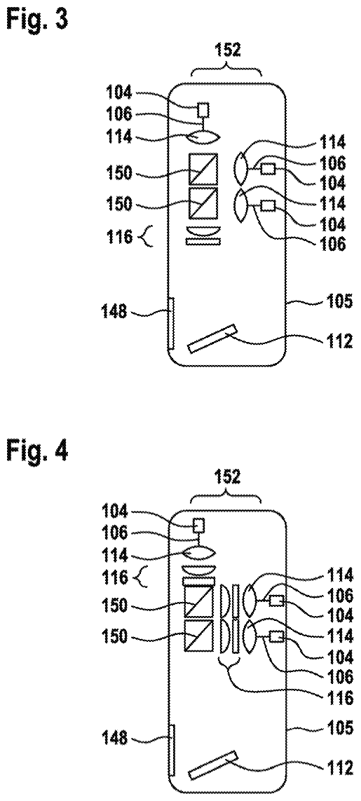

FIG. 3 shows another embodiment of the scanner optical unit 152, in which three different wavelengths are used, namely red, blue, and green. The three light sources 104 shown differ in the wavelength. The three different light beams 106, after they have each passed through a collimation element 114, are unified by means of two dichroic beam splitters 150 to form a single light beam 106, which then extends through a correction optical unit 116. The correction optical unit 116 according to FIG. 3 is designed and optimized for the three different wavelengths. After the correction optical unit 116, the light beam 106 is transmitted by the reflection element 112 through the exit window 148.

The scanner optical unit 152 shown in FIG. 4 differs from the one shown in FIG. 3 in that instead of the correction optical unit 116 after the two dichroic beam splitters 150, a correction optical unit 116 is arranged respectively between the collimation elements 114 and respectively one dichroic beam splitter 150 for each light source 104. These three correction optical units 116 are designed and optimized for the respective light wavelength used.

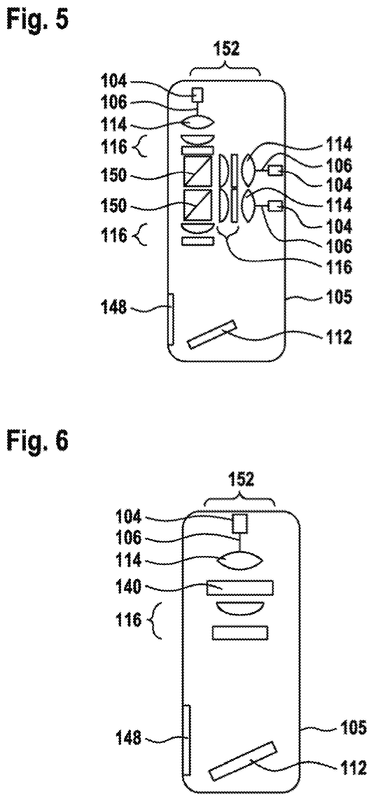

The scanner optical unit 152 shown in FIG. 5 differs from the one shown in FIG. 4 in that a further general-wavelength correction optical unit 116 is also additionally arranged after the dichroic beam splitters 150.

FIG. 6 shows a scanner optical unit 152, in which the light beam 106 emitted by a single light source 104 and collimated by a collimation element 114 passes through a combination of an adaptive optical element 140 and a correction optical unit 116 before it is incident on the reflection element 112. In this combination, the light beam 106 firstly passes through the adaptive optical element 140 and then the correction optical unit 116. According to a further embodiment, the arrangement of the adaptive optical element 140 and the correction optical unit 116 is exchanged.

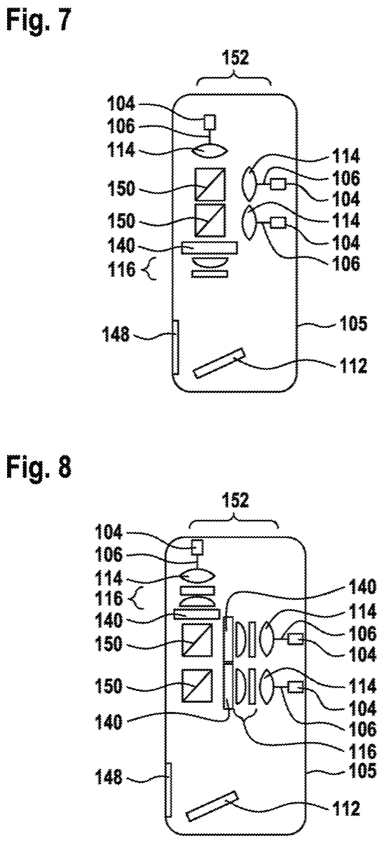

The scanner optical unit 152 shown in FIG. 7 differs from the one shown in FIG. 6 in that three light sources 104 having different wavelengths are used, which are unified by means of two dichroic beam splitters 150 to form a common light beam 106. The unified light beam 106 is then incident on the same combination of adaptive optical element 140 and the correction optical unit 116 as shown in FIG. 6. In this case, the arrangement of the adaptive optical element 140 and the correction optical unit 116 can also be exchanged.

The scanner optical unit 152 shown in FIG. 8 uses three light sources 104 having different wavelengths, wherein each of the three light beams 106 is firstly collimated, then passes through a correction optical unit 116, and lastly an adaptive optical element 140. The three light beams 106 are then unified by means of two dichroic beam splitters 150. In this embodiment, the respective correction optical units 116 and the respective adaptive optical elements 140 are designed and optimized for one wavelength.

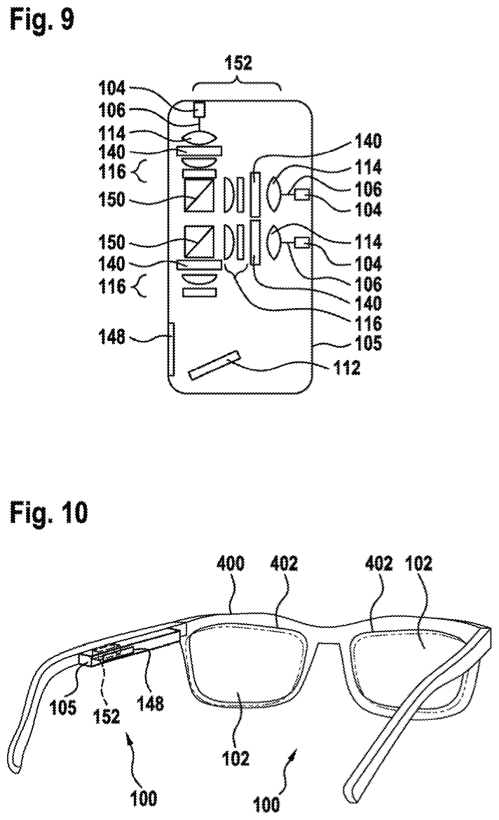

The scanner optical unit 152 shown in FIG. 9 differs from the one shown in FIG. 8 in that before the beam unification, the arrangement of the adaptive optical elements 140 and the correction optical units 116 is exchanged, and after the beam unification, as in FIG. 7, a combination of an adaptive optical element 140 and a correction optical unit 116 is located. According to a further embodiment, the arrangement of this combination can be exchanged.

FIG. 10 shows a schematic illustration of a pair of smart glasses 400 having a projection device 100 according to one exemplary embodiment. The projection device 100 comprises a scanner optical unit 152 and the deflection element 102 in this case. The scanner optical unit 152 is arranged in the housing 105 and emits a light beam 106 (not shown) through the exit window 148 onto the deflection element 102. The smart glasses 400 comprise a glasses lens 402, on which the deflection element 102 is arranged. For example, the deflection element 102 is implemented as a part of the glasses lens 402. Alternatively, the deflection element 102 is implemented as a separate element and connected by means of a suitable joining method to the glasses lens 402.

1. A projection device for a pair of smart glasses, the projection device comprising:
at least one light source configured to emit at least one light beam;
at least one collimation element configured to collimate the at least one light beam emitted by the light source;
at least one deflection element arranged on a glasses lens of the smart glasses, the at least one deflection element configured to project an image onto a retina of a user of the smart glasses by deflecting and/or focusing the at least one light beam onto an eye lens of the user;
at least one reflection element configured to reflect the collimated light beam onto the deflection element; and
at least one correction optical unit including a non-rotationally symmetrical optical element configured to at least one of improve a symmetry of the light beam and reduce a spot size of the light beam.

2. The projection device as claimed in claim 1, wherein the non-rotationally symmetrical optical element is a cylinder lens.

3. The projection device as claimed in claim 1, wherein the non-rotationally symmetrical optical element is not a diffractive optical element.

4. The projection device as claimed in claim 1, further comprising:
at least one adaptive optical element configured to adaptively change at least one beam parameter, the at least one adaptive optical element arranged in a beam path between the at least one light source and the at least one deflection element.

5. The projection device as claimed in claim 4, wherein the at least one adaptive optical element comprises one selected from the following group: a lens having variable refraction properties, a liquid lens having variable focal length, a telescope having variable focal length, a telescope having variable lens distances, a telescope having variable air spaces, a mirror having variable reflection properties, a mirror having a deformable surface, a liquid crystal mirror, a liquid crystal display, and an SLM in reflection based on liquid crystal technology.

6. The projection device as claimed in claim 4, wherein at least one of the at least one collimation element and the at least one correction optical unit comprises an adaptive optical element of the at least one adaptive optical element.

7. The projection device as claimed in claim 1, wherein the at least one light source comprises three light sources, each of which emits one light beam of a different wavelength, and the three different wavelengths of the three light sources form an RGB color space.

8. The projection device as claimed in claim 7, further comprising:
one of a light guide having diffractive coupling elements and dichroic beam splitters, the one of the light guide and the dichroic beam splitters configured to unify the light beams of the three light sources.

9. A pair of smart glasses comprising:
a glasses lens; and
a projection device, the projection device comprising:
at least one light source configured to emit at least one light beam;
at least one collimation element configured to collimate the at least one light beam emitted by the light source;
at least one deflection element arranged on the glasses lens, the at least one deflection element configured to project an image onto a retina of a user of the smart glasses by deflecting and/or focusing the at least one light beam onto an eye lens of the user;
at least one reflection element configured to reflect the collimated light beam onto the deflection element; and
at least one correction optical unit including a non-rotationally symmetrical optical element configured to at least one of improve a symmetry of the light beam and reduce a spot size of the light beam.

10. A method for improving a symmetry of a light beam and/or for reducing a diameter of the light beam, which is used in a projection device for a pair of smart glasses, the projection device including (i) at least one light source configured to emit at least one light beam, (ii) at least one collimation element configured to collimate the at least one light beam emitted by the light source, (iii) at least one deflection element arranged on a glasses lens of the smart glasses and configured to project an image onto a retina of a user of the smart glasses by deflecting and/or focusing the at least one light beam (106) on an eye lens of the user, and (iv) at least one reflection element configured to reflect the collimated light beam onto the deflection element, the method comprising:
adding at least one correction optical unit to the projection device, the at least one correction optical unit comprising a non-rotationally symmetrical optical element configured to at least one of improve the symmetry of the light beam and reduce a spot size of the light beam; and
carrying out a multiconfiguration optimization for optical components of the projection device to at least one of improve the symmetry and reduce the diameter of the light beam.

11. The method as claimed in claim 10, wherein the method is stored in a computer program.

12. The method of claim 11, wherein the computer program is stored on a machine-readable storage medium.

13. The method as claimed in claim 10, wherein the method is executed by an electronic control unit of the pair of smart glasses.
